(19) United States
(12) Patent Application Publication
(10) Pub. No.: US 2011/0075888 A1
(43) Pub. Date: Mar. 31, 2011

(54) COMPUTER READABLE MEDIUM, SYSTEMS AND METHODS FOR IMPROVING MEDICAL IMAGE QUALITY USING MOTION INFORMATION

(76) Inventor: Kazuhiko Matsumoto, Tokyo (JP)

(21) Appl. No.: 12/567,564

(22) Filed: Sep. 25, 2009

(51) Int. Cl. G06K 9/00; G09G 5/02

(52) U.S. Cl. 382/107; 345/589; 382/190; 382/131

(57) ABSTRACT

Motion information generated by comparing one or more instances of clinical volume data may be used in a variety of applications. Examples of applications described herein include filtering volume data and adjusting voxel intensity based on the motion information. Motion information may also be used to compress volume data. Combinations of these effects may also be achieved.

### TECHNICAL FIELD

The invention relates generally to medical image visualization techniques, and more particularly to the use of motion analysis in the visualization of images.

### BACKGROUND OF THE INVENTION

A variety of medical devices may be used to generate clinical images, including computed tomography (CT) and magnetic resonance imaging (MRI) scanners. These scanners may generate volume data of human anatomy. In this manner, multiple instances of volume data of an anatomical feature may be generated, and may capture movement or other changes of the feature over time.

For example, 3D clinical images may include cardiac scans with scan intervals under a second. In other examples, the 3D scans may include continuous ultrasound scans generating multiple images per second. In this manner, images may be obtained of deformable organs or other features which may change shape from scan-to-scan depending on a variety of variables, such as a patient's posture or breathing pattern. Due in part to these deformations, image quality may vary from scan to scan. Noise from the scanning device may also detract from image quality. Accordingly, filters may be needed to improve image quality.

Motion analysis techniques exist for correlating features in two images. The motion analysis techniques may identify spatial transformation between images, and may generate a displacement vector for each pixel of the image.

Some video systems leverage motion analysis information to smooth playback capability. A video sequence usually contains a set of images sampled with a fixed time interval. The spatial transformation may be used to insert an image between two regularly spaced video frames that may improve the smoothness of playback.

While motion analysis techniques have been used to interpolate between regularly sampled video frames, motion analysis techniques have not been widely exploited in the clinical setting.

### BRIEF DESCRIPTION OF THE DRAWINGS

FIG. 1 is a schematic illustration of a system in accordance with an embodiment of the invention.

FIG. 2 is a schematic illustration of two heart images representing volume data processed to yield motion information.

FIG. 3 is a schematic illustration of a system including executable instructions for filtering in accordance with an embodiment of the invention.

FIG. 4 is a flowchart for a method to filter volume data in accordance with the embodiment of FIG. 3.

FIG. 5 is a schematic illustration of filtered volume data in accordance with the embodiment of FIG. 3.

FIG. 6 is a schematic illustration of a system including executable instructions for reducing intensity variation according to another embodiment of the present invention.

FIG. 7 is a flowchart of a method of reducing intensity variation in accordance with the embodiment of FIG. 6.

FIG. 8 is a schematic illustration of the use of motion information to reduce intensity changes between instances of volume data in accordance with the embodiment of FIG. 6.

FIG. 9 is a schematic illustration of a system including executable instructions for volume data compression according to a further embodiment of the present invention.

FIG. 10 is a flowchart of a method for volume data compression in accordance with the embodiment of FIG. 9.

### DETAILED DESCRIPTION

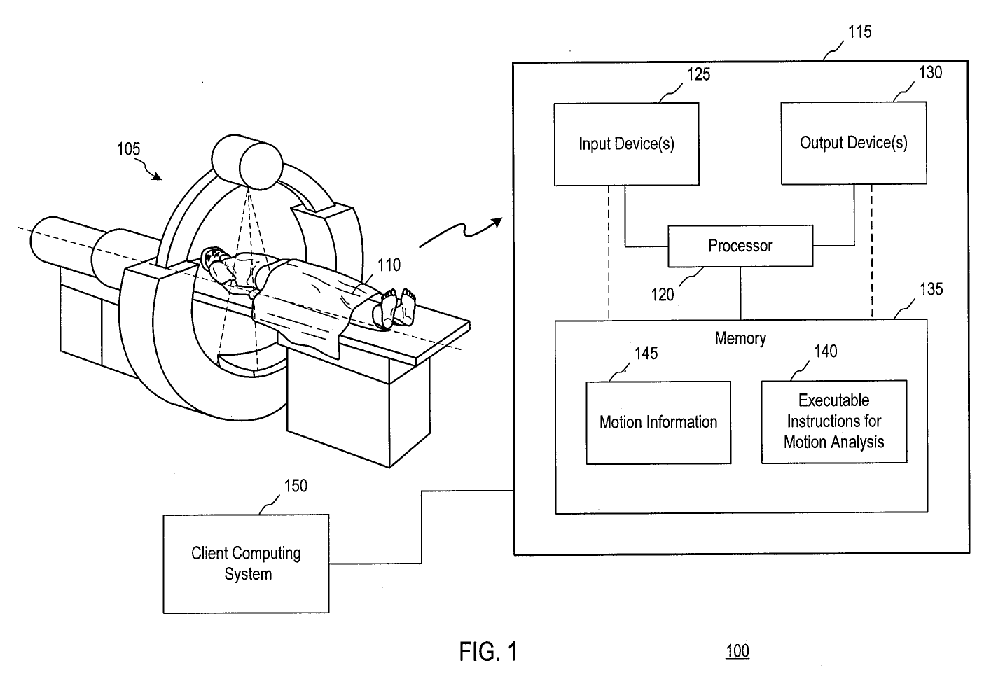

FIG. 1 is a schematic illustration of a medical scenario 100 in accordance with an embodiment of the invention. A computed tomography (CT) scanner 105 is shown and may collect data from a subject 110. The data may be transmitted to an imaging system 115 for processing. The imaging system 115 may include a processor 120, input devices 125, output devices 130, a memory 135, or combinations thereof As will be described further below, the memory 135 may store executable instructions for performing motion analysis 140. Following the processing of volume data using motion analysis, motion information 145 may be stored in the memory 135. The motion information 145 may be used in a variety of ways, as will be described further below, to generate or alter volume data that may be displayed on one or more of the output devices 130 or transmitted for display by a client computing system 150. The client computing system 150 may communicate with the imaging system 115 through any mechanism, wired or wireless.

Embodiments of the present invention are generally directed to processing of volume data. Volume data as used herein generally refers to three-dimensional images obtained from a medical scanner, such as a CT scanner, an MRI scanner, or an ultrasound. Data from multiple scans that may occur at different times may be referred to as different instances of volume data. Other scanners may also be used. Three-dimensional images or other visualizations may be rendered or otherwise generated using the volume data. The visualizations may represent three-dimensional information from all or a portion of the scanned region.

Any of a variety of input devices 125 and output devices 130 may be used, including but not limited to displays, keyboards, mice, network interconnects, wired or wireless interfaces, printers, video terminals, and storage devices.

Although shown encoded on the same memory 135, the, motion information 145 and the executable instructions for motion analysis 140 may be provided on separate memory devices, which may or may not be co-located. Any type of memory may be used.

Although a CT scanner 105 is shown, data according to embodiments of the present invention may be obtained from a subject using any type of medical device suitable to collect data that may be later imaged, including an MRI scanner or ultrasound scanner.

It is to be understood that the arrangement of computing components and the location of those components is quite flexible. In one example, the imaging system 115 may be located in a same facility as the medical scanner acquiring data to be sent to the imaging system 115, and a user such as a physician may interact directly with the imaging system 115 to process and display clinical images. In another example, the imaging system 115 may be remote from the medical scanner, and data acquired with the scanner sent to the imaging system 115 for processing. The data may be stored locally first, for example at the client computing system 150. A user may interface with the imaging system 115 using the client computing system 150 to transmit data, provide input parameters for motion analysis, request image analysis, or receive or view processed data. In such an example, the client computing system 150 need not have sufficient processing power to conduct the motion analysis operations described below. The client computing system may send data to a remote imaging system 115 with sufficient processing power to complete the analysis. The client computing system 150 may then receive or access the results of the analysis performed by the imaging system 115, such as the motion information. The imaging system 115 in any configuration may receive data from multiple scanners.

Any of a variety of volume data may be manipulated in accordance with embodiments of the present invention, including volume data of human anatomy, including but not limited to, volume data of organs, vessels, or combinations thereof.

Having described a basic configuration of a system according to embodiments of the present invention, motion analysis techniques will now be described. One or more of the motion analysis techniques may be used to generate motion information, and the resulting motion information may be used to generate or alter clinical volume data in a variety of ways.

Motion analysis techniques applied for volume data generally determine a spatial relationship of features appearing in two or more instances of volume data. A feature may generally be any anatomical feature or structure, including but not limited to an organ, muscle or bone, or a portion of any such anatomical feature or structure, or a feature may be a point, a grid or any other geometric structure created or identified in a volume data of the patient. In embodiments of the present invention, motion analysis may be performed on a plurality of three-dimensional clinical instances of volume data derived from a subject using a scanner. The instances of volume data may represent scans taken a certain time period apart—such as milliseconds in the case for example of CT scans, such as those used to capture left ventricle motion in a heart, or days or months apart in the case for example of scans to observe temporal changes of lesions or surgical locations. The image processing system 115 of FIG. 1 may perform motion analysis to determine a spatial transformation between multiple instances of volume data. In particular, executable instructions for motion analysis 140 may direct the processor 120 to identify corresponding features in different instances of volume data. This feature correspondence may be used to derive a displacement vector for any number of features in the instances of volume data, or all of the features. The displacement vector may represent the movement of the feature in one instance of volume data to the next. The resulting motion analysis information, which may include a representation of the displacement vector, or another association between corresponding features or voxels in two instances of volume data, may be stored in a memory or other storage device, such as the memory 135 of FIG. 1.

Motion analysis techniques to identify one or more spatial transformations that map points in one image to the corresponding points in another image are known in the art. The spatial transformation may generally be viewed as representing a continuous 3D transformation. Typical techniques may be classified into three categories—landmark based, segmentation based, and intensity based. In landmark based techniques, a set of landmark points may be specified in all volume data instances. For example, a landmark may be manually specified at points of anatomically identifiable locations visible in all volume data instances. A spatial transformation can be deduced by the given landmarks. In segmentation based techniques, segmentation of target objects may be performed prior to the motion analysis process. Typically, the surface of the extracted objects may be deformed so as to estimate the spatial transformation that aligns the surfaces. In intensity based techniques, a cost function that penalizes asymmetry between two images may be used. The cost function may be based on voxel intensity and the motion analysis process may be viewed as a problem to find a best parameter of the assumed spatial transformation to maximize or minimize the returned value. Depending on selection of the cost function and optimizer, a wide variety of methods may be used. Any of these techniques ultimately identify one or more spatial transformations between two or more instances of volume data and motion information may be derived from the spatial transformation, for example by calculating a displacement vector for a voxel. In some examples, a system may be capable of performing motion analysis utilizing multiple techniques, and a user may specify the technique to be used. In some examples, a system may perform motion analysis utilizing multiple techniques, and a user may select a technique that produces desirable results.

The motion information may also be used to provide quantitative information such as organ deformation (distance) in CT scans or velocity changes in ultrasound scans. Since motion information defines spatial mapping of points, strain analysis that measures an extent of deformation of a local region may be performed quantitatively.

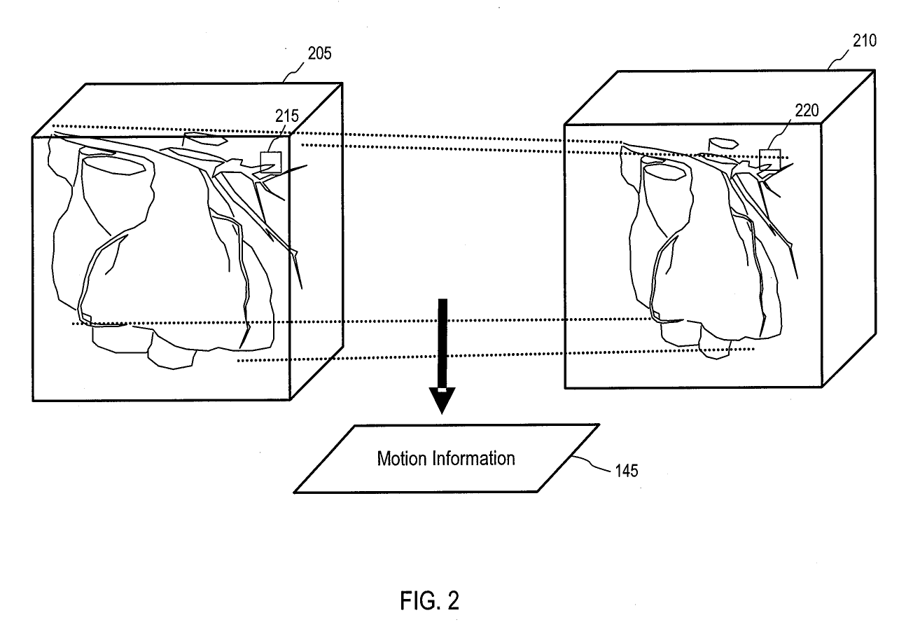

FIG. 2 is a schematic illustration of a first image representing a first instance of volume data 205 and a second image representing a second instance of volume data 210 of a heart. Applying the motion analysis techniques described above, the processor 120 of FIG. 1 may determine a spatial transformation between the points 215 of the first instance of volume data and the points of the second instance of volume data 220. That is, motion analysis identifies where a point shown in a particular feature in the first instance of volume data has moved to in the second instance of volume data. So, for example, if a feature is shown first at point A of the first instance of volume data, and then at point B of the second instance of volume data, the motion information would indicate that feature A and B were corresponding features, and may store a displacement vector representing a spatial transformation between the features A and B. This correspondence may be used to generate motion information 145. An association between these points 215 and 220 may accordingly be stored, or a vector representing the motion of the point 215 to the location of the point 220 may be stored, or both. In some examples, the motion information may not be immediately stored, but may be communicated to another processing device, computational process, or client system.

Motion information generated by comparing one or more clinical instance of volume data may be used to process volume data in a variety of ways. In general, applications described herein relate to the improvement of image quality using the motion information.

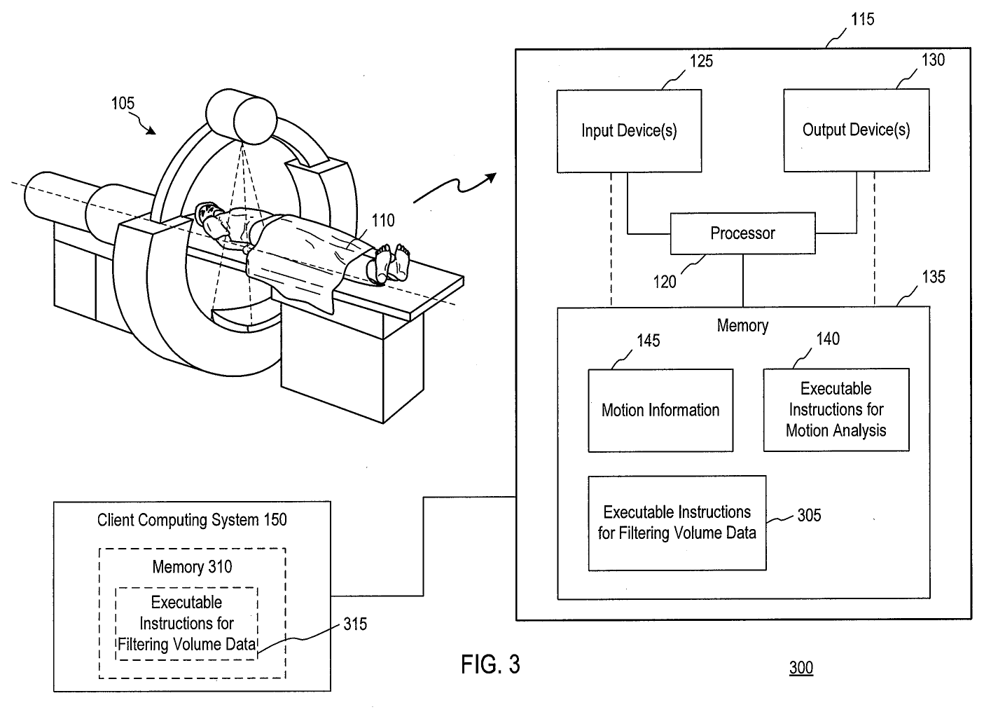

Embodiments of the system and method of the invention may filter volume data based on motion information. FIG. 3 is a schematic illustration of a medical scenario 300 including the imaging system 115 which includes executable instructions for filtering at least one instance of volume data 305. While shown as encoded in the memory 135, the executable instructions 305 may reside on or be executed by any computing system, including the client computing system 150, which may include the memory 310 having executable instructions for filtering 315. The client computing system 150 may access the motion information 145 or receive the motion information from the imaging system 115 and filter volume data locally. Alternatively or in addition, volume data may be filtered by the imaging system 115 itself Generally the process of filtering the volume data may alter intensity values, particularly at voxels where the intensity values may have a lower signal-to-noise ratio, or lower dynamic range due to artifacts, noise, or combinations thereof The motion information is utilized to identify areas where intensity may be advantageously adjusted and to make an appropriate intensity adjustment.

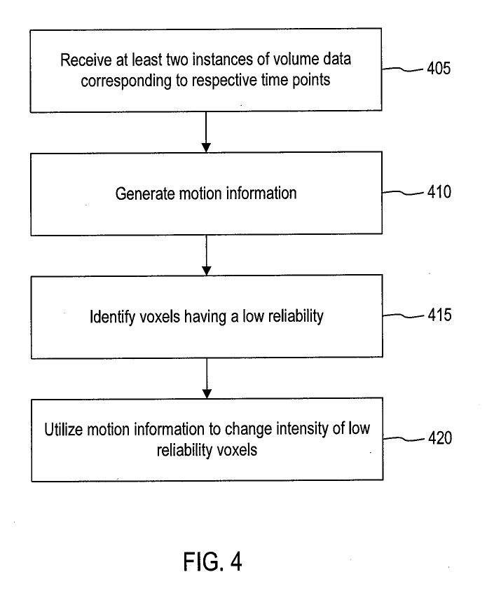

An schematic flowchart for a method to filter volume data according to an embodiment of a system and method of the present invention is shown in FIG. 4. At block 405, volume data may be received for at least two instances of volume data at respective time points. For example, the volume data may be volume data instances from a heart scan within milliseconds of one another, or volume data instances of an organ taken weeks, months, or years apart. The received volume data may generally include the same clinical target. In block 410, motion information is generated based on one or more spatial transformations between instances of volume data, as has been described above, such as the correspondence between the points 215 and 220 in FIG. 2. In block 415, voxels having a low reliability are identified in at least one instance of volume data. The reliability may be defined as a function of scan time, location, value, motion, velocity, acceleration, or a combination of those values. In one example, rapid movement of a tissue may introduce artifacts to an instance of volume data. Accordingly, voxels corresponding to a rapidly moving feature would be considered less reliable. In another example, voxels in a vicinity of a significantly high intensity region may experience artifacts. The significantly high intensity region may be defined, for example, as a region having an intensity that is greater than the average intensity by a threshold amount. Accordingly, voxels in the vicinity of a high intensity region may have lower reliability. In block 420, the motion information is utilized to change the low reliability voxels. Any type of filter may be designed to change the low reliability voxels, including filters to perform smoothing, edge enhancement, maximum intensity projection, minimum intensity projection, difference, accumulated addition, histogram matching, or any combination of these. The filtering process may correct the intensity of lower reliability voxels and may equalize image quality, signal-to-noise ratio, dynamic range, or combinations of those.

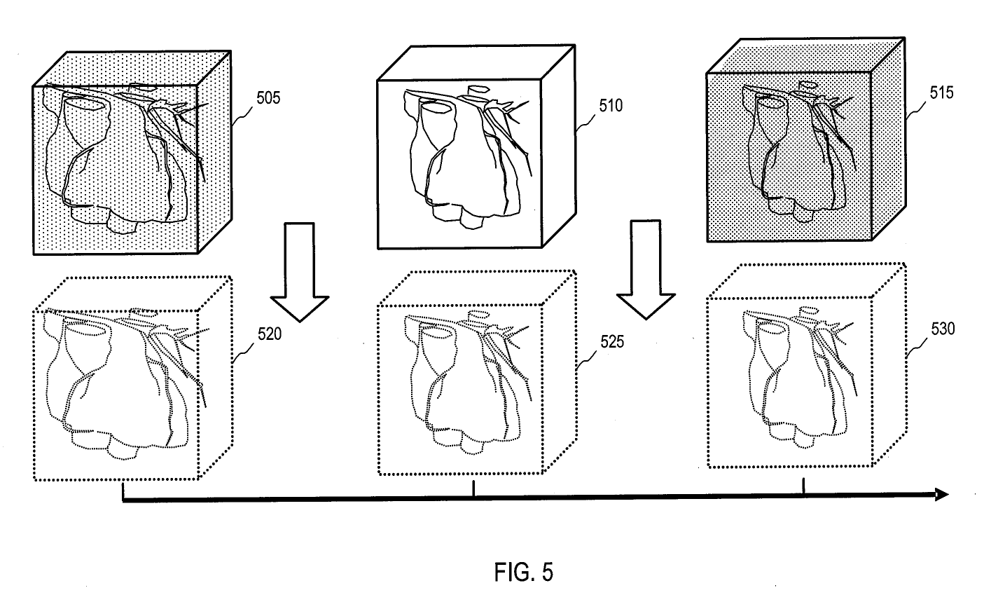

FIG. 5 is a schematic illustration of an example of volume data filtered using techniques described above, for example in accordance with the method of FIG. 4. A first instance of volume data 505, second instance of volume data 510, and third instance of volume data 515 may be received. The first instance of volume data 505 and third instance of volume data 515 may have been acquired at time points during deformation of the target feature, while the second instance of volume data 510 may have been acquired at a stable time. Accordingly, some voxels or features in the first and third instances of volume data 505 and 510 may be identified as having a lower reliability. Motion information may be obtained from the first, second, and third instances of volume data 505, 510, and 515 to identify feature correspondence between the instances of volume data. One or more of the instances of volume data may then be filtered to generate the instances of filtered volume data 520, 525, and 530. The intensity values of voxels in the instances of volume data 505 and 515 may be improved based on the feature correspondence. For example, the intensity values of voxels in the instances of volume data 505 and 515 may be adjusted based on an average intensity values at corresponding points in the other two instances of volume data as identified by the motion information. Other functions besides averaging may also be used to adjust the intensity value.

While the example described with reference to FIG. 5 described intensity variation based on deformation of an organ, in other examples intensity variations may be adjusted that may not be caused by geometry or shape of an organ or other feature. In some examples, artifacts may be adjusted that were caused by a gradient or interference between regions of higher and lower intensities. The intensity distortion may be represented as a function of scan time, location, intensity value, motion, velocity, or acceleration of a target region, or combinations thereof. From the spatial transformation between two instances of volume data, a function for intensity distortion may be estimated, and a correction performed to eliminate or reduce the distortion. A voxel may have a less reliable intensity value or may have intensity distortion for any of a variety of reasons. In a CT scan, low reliability or distortion may be caused by rotation or deformation of an organ from local expansion or shrinkage. In an MRI scan, displacement, scan time, and regions of high intensity may cause distortion. In ultrasound scans, velocity change may degrade image quality. The above-described filtering techniques may reduce or eliminate these distortions.

Examples of filtering volume data based on motion information have been described above. It is to be understood that computer software, including a computer readable medium encoded with instructions to perform all or a portion of the above methods may also be provided, as can be computing systems configured to perform the methods, as has been generally described. The systems may be implemented in hardware, software, or combinations thereof.

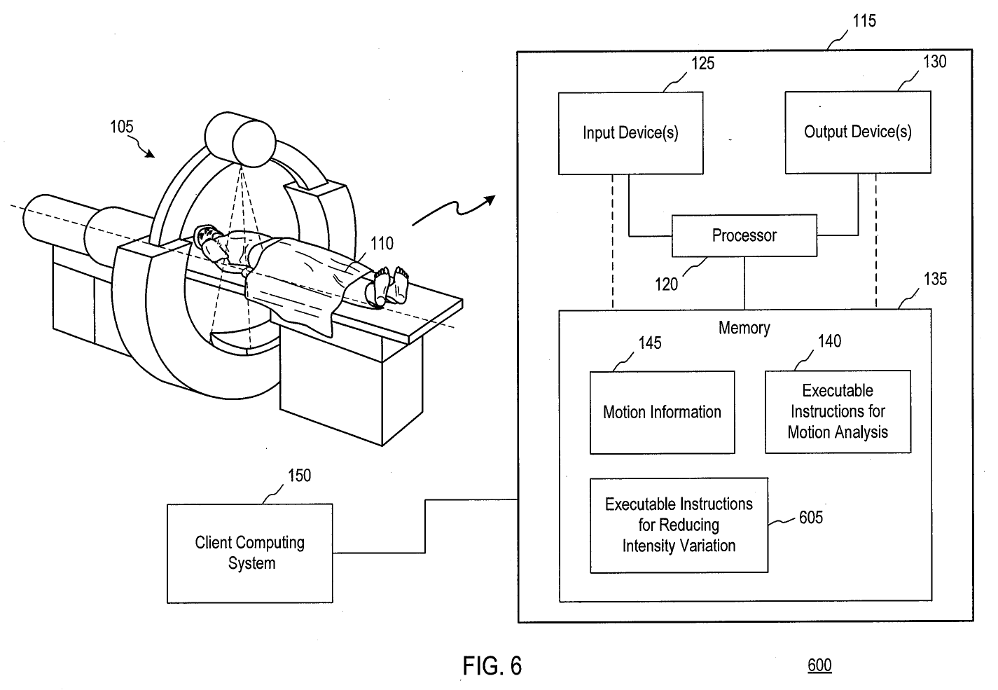

Motion information may also be used to adjust intensity values to improve the visibility of a moving feature in a series of volume data instances. If visualization of a moving feature is desired, it may be distracting for a sequence of volume data to vary in intensity, because the intensity variation may obscure the motion. Nonetheless, intensity may vary from one instance of volume data to another in a sequence for any of a variety of reasons including contrast agent dosage changes or the movement itself FIG. 6 is a schematic illustration of a medical scenario 600 including the imaging system 115 which includes executable instructions for reducing intensity variation 605. While shown as encoded in the memory 135, the executable instructions 605 may reside on any computer readable medium accessible to the processor 120, or alternatively may stored or executed, or both, by the client computing system 150.

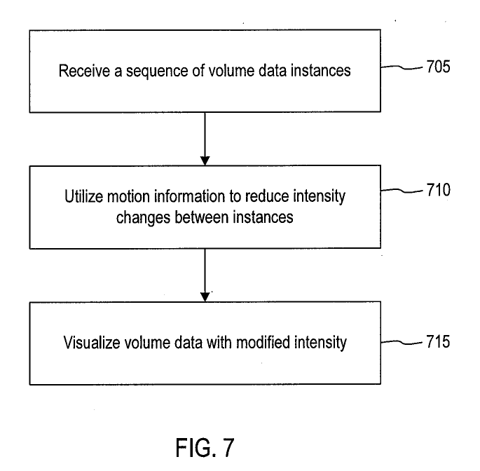

FIG. 7 is a flowchart providing an overview of a method of reducing intensity variation in accordance with the system of FIG. 6. In block 705, a sequence of instances of volume data is received. Any number of volume data instances may be included in the sequence, and the sequence may be taken over any range of time, including over several seconds, days, months, or years. Motion information including a feature correspondence between volume data instances in the sequence may be generated and stored, as generally described above. In block 710, the motion information may be used to reduce intensity changes between the volume data instances. For example, a voxel's intensity may be adjusted in each volume data instance to be equal to an average intensity at the corresponding point in each of the series of volume data instances. That is, the motion information identifies corresponding points in each of the series of volume data instances. Accordingly, an intensity value may be identified in each volume data instance for the same corresponding point. An average of the intensity values may be taken, and the average value used to represent the corresponding point in each of the volume data instances. In this manner, the intensity values of one or more voxels in each of the volume data instances may be updated such that the intensity of corresponding points does not change across the sequence, or the change is reduced. By reducing the intensity variation, the motion of the features may be more easily observed. It is to be understood that the corresponding points do not refer to the same point in multiple volume data instances, but rather corresponding points refer to the point correspondence identified by the motion information, which will generally refer to a same feature or position within a feature of a volume data instance. So corresponding points may be in different positions in each instance of volume data. In block 715, the volume data instance with modified intensity may be stored, displayed, or both.

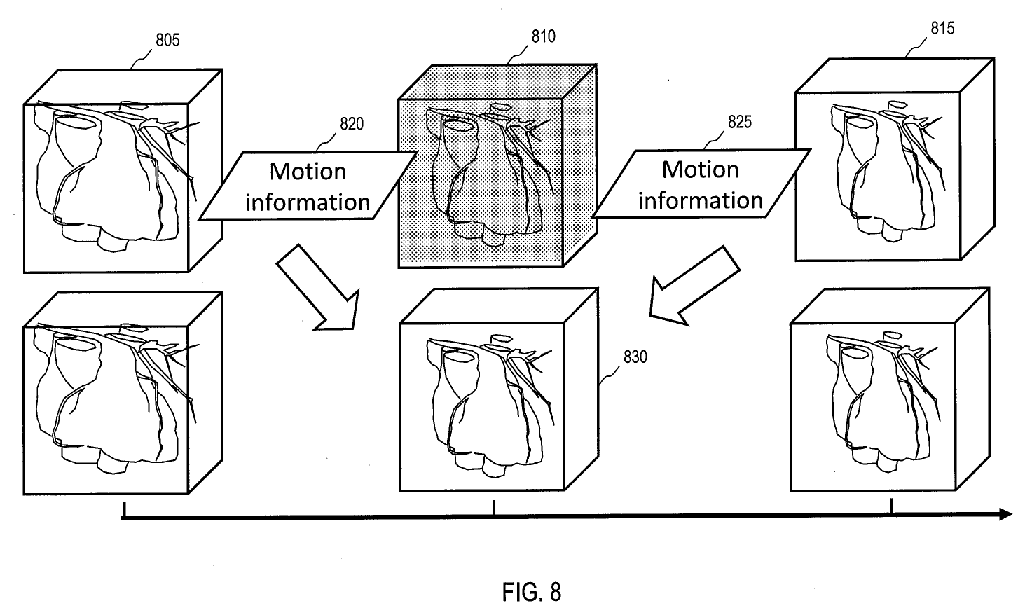

FIG. 8 is a schematic illustration of an example of the use of motion information to reduce intensity changes between volume data instances in accordance with the scenario of FIG. 6 and the method of FIG. 7. A sequence of three instances of volume data 805, 810, and 815 is shown. These instance of volume data may have been obtained from CT scans of a subject, where a radiation dose may be correlated with a quality of the received volume data. In the example shown in FIG. 8, the instances of volume data 805 and 815 were obtained using a normal level of radiation dose, however, the instance of volume data 810 was obtained using a lower radiation dose, and consequently is of lesser quality. Motion information 820 and 825 is generated that identifies feature correspondence between the volume data 805-810 and 810-815, respectively. The motion information may then be used to adjust intensities or other parameters of voxels in the instance of volume data 810 to generate the higher quality volume data 830. The higher quality volume data 830 may have intensity levels approximating those in the instances of volume data 805 and 815. In this manner, a lower radiation dose may be used for some scans and may reduce an overall radiation dose required for a subject. In a similar manner, quality of volume data may be adjusted when different scan techniques or parameters are used for different instances of volume data in a sequence.

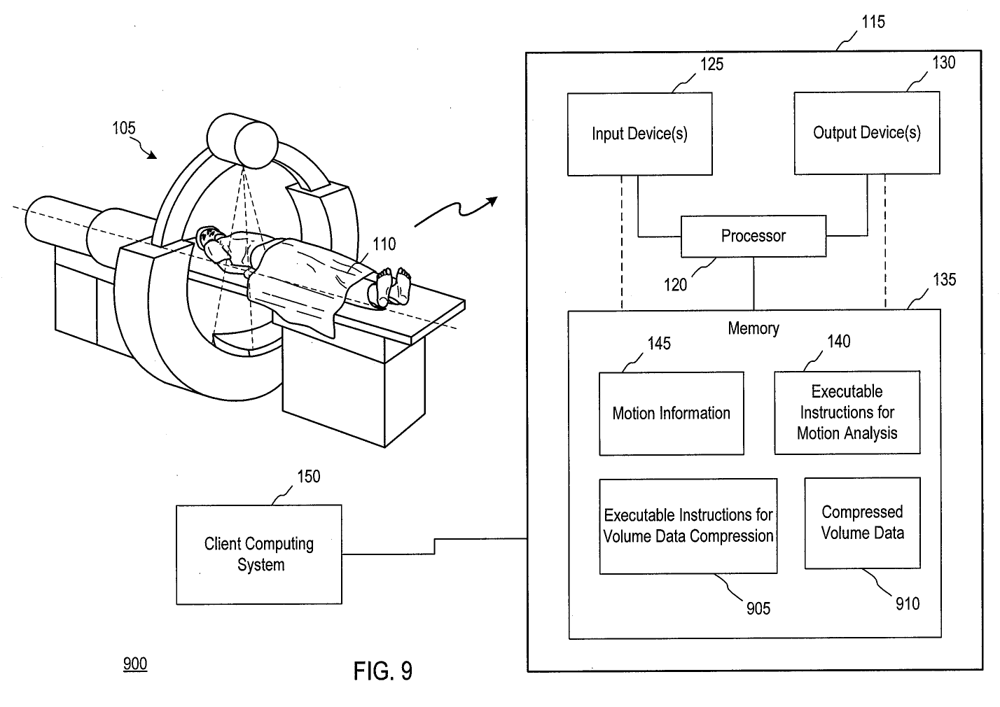

The motion information may also be used to compress multiple instances of volume data acquired over time without significantly degrading image quality. FIG. 9 is a schematic illustration of a medical scenario 900 including the imaging system 115 which includes executable instructions for volume data compression 905 and compressed volume data 910 may also be stored in the memory 135. While shown as encoded in the memory 135, the executable instructions 905 and compressed volume data 910 may reside on any computer readable medium accessible to the processor 120, or alternatively may stored or executed, or both, by the client computing system 150.

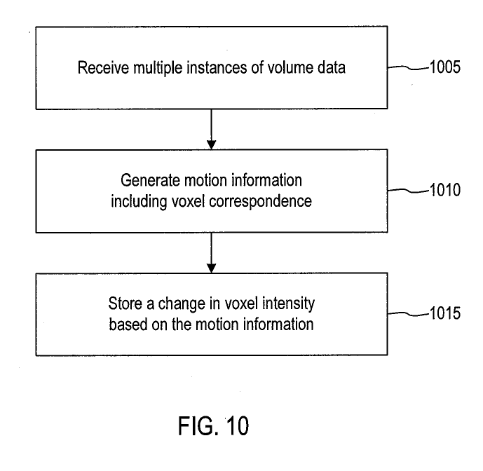

The executable instructions for volume data compression 905 may include instructions for transforming intensity data associated with one or more voxels using the motion information 145. A flowchart of an example methodology in accordance with the system of FIG. 9 is shown in FIG. 10. In block 1005, multiple instances of volume data may be received. The volume data may be represented by volume data having several bits of intensity information per voxel. Motion information is generated in block 1010 including point correspondence in the multiple instances of volume data. Since a correspondence has been identified between points in the instances of volume data, some of the instances of volume data may not need to store all the intensity information for each voxel. Instead, only information related to a change in the intensity from the corresponding point in another instance of volume data, such as a previous or subsequent instance of volume data, may be stored in block 1015. In this manner, fewer bits may be needed to store the intensity information, allowing for a smaller storage size while maintaining the quality of the volume data.

Certain details have been set forth above to provide a sufficient understanding of embodiments of the invention. However, it will be clear to one skilled in the art that embodiments of the invention may be practiced without one or more of these particular details. In some instances, well-known circuits, control signals, timing protocols, and software operations have not been shown in detail in order to avoid unnecessarily obscuring the described embodiments of the invention.

From the foregoing it will be appreciated that, although specific embodiments of the invention have been described herein for purposes of illustration, various modifications may be made without deviating from the spirit and scope of the invention.

What is claimed is:

1. A computer readable medium for use with motion information derived in part from first and second instance of volume data of the human anatomy and including a representation of a spatial transformation of a feature included in the first and second instances of volume data, the computer readable medium encoded with instructions that when executed cause a processor to specify at least one set of corresponding features in the first and second instances of volume data based at least in part on the motion information, and to adjust an intensity of at least one of the specified corresponding features in the first instance of volume data so as to enhance the quality of an image derived from the first instance of volume data.

2. The computer readable medium of claim 1 wherein the instructions further cause the processor to generate the motion information.

3. The computer readable medium of claim 1 wherein the first and second instances of volume data were generated by a procedure selected from the group consisting of magnetic resonance imaging and computer tomography.

4. The computer readable medium of claim 1 wherein the motion information includes a displacement vector of the feature.

5. The computer readable medium of claim 1 wherein the instructions for adjusting include instructions for adjusting the intensity of the at least one of the corresponding features in the first instance of volume data is based in part on a reliability of the specified features in the first and second instances of volume data.

6. The computer readable medium of claim 5 wherein the reliability is based in part on the motion information.

7. The computer readable medium of claim 5 wherein the first volume data has a significantly high intensity region and the reliability is based in part on a distance to the high intensity region of the first instance of volume data.

8. The computer readable medium of claim 5 wherein the reliability is based on a condition of acquisition of the first instance of volume data.

9. The computer readable medium of claim 5 wherein the reliability is based on an amount of deformation of the feature in the first and second instances of volume data.

10. The computer readable medium of claim 1 wherein the instructions for adjusting the intensity include instructions for averaging an intensity of the at least one of the corresponding features in the first and second instances of volume data, and assigning the average value to the intensity of at least one of the associated voxels in the first instance of volume data.

11. The computer readable medium of claim 1 wherein the instructions for adjusting the intensity include instructions for assigning an intensity value of a voxel in the second instance of volume data as the intensity of at least one of the corresponding features in the first instance of volume data.

12. The computer readable medium of claim 1 wherein the instructions further cause the processor to measure the difference in intensity between the at least one of the corresponding features in the first instance of volume data and a corresponding feature in the second instance of volume data and represent an intensity of at least one of the corresponding features in the first instance of volume data as the difference in intensity.

13. The computer readable medium of claim 1 wherein the instructions further cause the processor to visualize the first instance of volume data on a display device after adjusting the intensity.

14. A system for improving the quality of an image of the human anatomy, the system comprising:
an input terminal configured to receive first and second instances of volume data of the human anatomy;
a processor; and
a computer readable medium coupled to the processor and encoded with computer executable instructions that when executed cause the processor to analyze the first and second instances of volume data, generate motion information, measure the intensity of corresponding points in the first and second instances of volume data as specified by the motion information and adjust the intensity of at least one of the voxels in the first instance of volume data so as to enhance the quality of an image derived from the first instance of volume data.

15. The system of claim 14 wherein the computer readable medium further stores the motion information.

16. The system of claim 14 further including a display device configured to display the first and second instances of volume data including the voxels having adjusted intensity.

17. A method for improving the quality of an image of the human anatomy, comprising receiving first and second instances of volume data of the human anatomy, specifying at least one set of corresponding points in the first and second instances of volume data based at least in part on motion information that includes at least one representation of a spatial transformation of a feature included in the first and second instances of volume data, and adjusting the intensity of at least one of the specified corresponding points in the first instance of volume data so as to enhance the quality of an image derived from the first instance of volume data.

18. The method of claim 17 further comprising employing motion analysis to identify the spatial transformation of the feature in the first and second instances of volume data and generate the motion information.

19. The method of claim 17 wherein the receiving step includes receiving the first and second instances of volume data generated by a procedure selected from the group consisting of magnetic resonance imaging and computer tomography.

20. The method of claim 17 wherein the motion information includes a displacement vector of the feature.

21. The method of claim 17 wherein the step of adjusting the intensity includes adjusting the intensity of at least one of the corresponding points in the first instance of volume data based in part on a reliability of the corresponding points in the first and second instances of volume data.

22. The method of claim 20 wherein the reliability is based in part on the motion information.

23. The method of claim 20 wherein the first instance of volume data has a significantly high intensity region and the reliability is based in part on a distance to the high intensity region of the first instance of volume data.

24. The method of claim 20 wherein the reliability is based on a condition of acquisition of the first instance of volume data.

25. The method of claim 20, wherein the reliability is based on an amount of deformation of the feature in the first and second instances of volume data.

26. The method of claim 17 further comprising averaging an intensity of at least one of the corresponding points in the first and second instances of volume data, and assigning the average value to the intensity of at least one of the associated voxels in the first instance of volume data.

27. The method of claim 17 wherein the step of adjusting the intensity includes adjusting the intensity of the at least one of the voxels in the first instance of volume data to be equal to the intensity of the corresponding point in the second instance of volume data.

28. The method of claim 17 further comprising measuring the difference in intensity between the at least one of the voxels in the first instance of volume data and the corresponding point in the second instance of volume data and representing the intensity of the at least one of the voxels in the first instance of volume data as the difference in intensity.

29. The method of claim 17 further comprising visualizing the first instance of volume data on a display device after the adjusting the intensity.
